(19) United States
(12) Patent Application Publication
(10) Pub. No.: US 2018/0271076 A1
(43) Pub. Date: Sep. 27, 2018

(54) FISHING LINE WINDING DEVICE

(71) Applicant: James Holmgren, Joliet, IL (US)

(72) Inventor: James Holmgren, Joliet, IL (US)

(21) Appl. No.: 15/469,694

(22) Filed: Mar. 27, 2017

(51) Int. Cl. A01K 89/00; A01K 89/0155; B65H 75/00

(52) U.S. Cl. CPC A01K 89/003; A01K 89/0111; B65H 75/00; A01K 89/01556

(57) ABSTRACT

A winding machine for winding fishing line from a spool onto the reel of a fishing rod is disclosed. The winding machine incorporates a novel spring-loaded tongue that is adapted to provide a light pressure onto the fishing line as it is wound onto the reel thereby preventing backlash. The disclosed winding machine is portable and can be field-deployed on either the wall of a boat or on any other convenient, reasonably flat surface.

### FIELD OF THE DISCLOSURE

The present disclosure generally relates to winding devices for reeled lines, and particularly relates to fishing line winding devices, and more particularly still relates to fishing line winding devices that prevent backlash.

### BACKGROUND

Generally, new fishing line is wound onto a regular casting fishing reel in the same manner as line cast from a spinning reel is retrieved; i.e., by manual operation of a hand crank or handle. Winding new line onto the spool of a fishing reel in such a manner is tiresome, time-consuming, and generally inefficient. Nonetheless, fishing line becomes worn out and needs to be replaced; in addition, during normal use while fishing, the line on a reel can become tangled or otherwise damaged, and need to be replaced. When this occurs, an angler using prior art solutions has little choice but to manually wind line onto his fishing reel.

In addition, when fishing line is manually wound onto a bait casting reel it can develop backlash. Backlash are tangles within a fishing line, and are sometimes referred to as birds nests or just tangles. Backlash can develop when, for example, a line is cast and the line hits the water. At that point, the reel continues to run but the line slows and stops at which point backlash can develop. In addition, if a reel is wound nonuniformly, the reel can be far more susceptible to developing backlash during normal operation.

Certain winding devices have been employed in the past. For example, drill powered devices and heavy devices that are effectively immobile have been employed by anglers to aid in winding fishing line onto a reel. However, none of these devices employed the novel configuration present in the disclosed device, or the backlash eliminating features of the disclosed device.

### OBJECTS OF THE DISCLOSED WINDING DEVICE

One object of the disclosure is to provide an improved winding device for winding fishing line onto a fishing rod's reel.

Another object of the disclosure is to provide an easily portable winding device for winding fishing line onto a fishing rod's reel.

Another object of the disclosure is to provide a winding device for winding fishing line onto a fishing rod's reel that can be deployed at a fishing site.

Another object of the disclosure is to provide a winding device for winding fishing line onto a fishing rod's reel that prevents the formation of backlash.

Other advantages of this disclosure will be clear to a person of ordinary skill in the art. It should be understood, however, that a system or method could practice the disclosure while not achieving all of the enumerated advantages, and that the protected disclosure is defined by the claims.

### SUMMARY OF THE DISCLOSURE

A winding machine for winding fishing line from a spool onto a reel is disclosed herein. In one embodiment the winding machine comprises a substantially rectangular mounting plate and a substantially circular backing plate coupled to the mounting plate. In this embodiment the winding machine further comprises a retainer that includes a top retaining beam coupled to the mounting plate and the top of the circular backing plate and a bottom retaining beam coupled to the mounting plate and the bottom of the circular backing plate. The circular backing plate also has a center axle disposed at its center and protruding outwards therefrom. In addition, a post is disposed on the circular backing plate at a location radially outwards from the center axle near the edge of the circular backing plate and near where the circular backing plate is coupled to the top retaining beam. A spring is disposed on the post and a tongue is mounted on an end of the spring. During operation, a spool of fishing line is placed on the center axle, and the line is fed into the reel of a fishing rod. The reel is then spun and line is fed onto the reel. While line is fed onto the reel, the tongue provides modest pressure on the line, thereby preventing the formation of backlash.

In a further embodiment of the disclosed winding machine, a mounting channel is disposed on the mounting plate. In addition, the retainer can further comprise a rear beam with a protrusion disposed on the rear beam that is adapted to couple with the mounting channel.

In yet another embodiment of the disclosed winding machine, a holder is formed on the same side of the backing plate as the post, and one end of the spring is disposed within the holder.

In a further embodiment of the disclosed winding machine, the mounting plate further comprises a hook and fastener backing that is adapted to couple with a hook and fastener sheet that can be mounted, for example, to the wall of a boat or any other reasonably flat surface. This allows the disclosed winding machine to be deployed by an angler in the field.

In a further embodiment of the disclosed winding machine, the mounting plate can be constructed of wood or plastic.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is an exploded view of a fishing line winding device constructed in accordance with this disclosure.

FIG. 1a is a perspective view of an optional mounting channel that can be used with the disclosed winding device.

FIG. 2 is a side view of the disclosed winding device, with the mounting plate not shown.

FIG. 3 is a perspective view of the disclosed winding device in operation as it is used to wind fishing line onto the reel of a fishing rod.

FIG. 4 is a perspective view of the disclosed winding device in operation as it is used to wind fishing line onto an alternative reel of a fishing rod.

### DETAILED DESCRIPTION

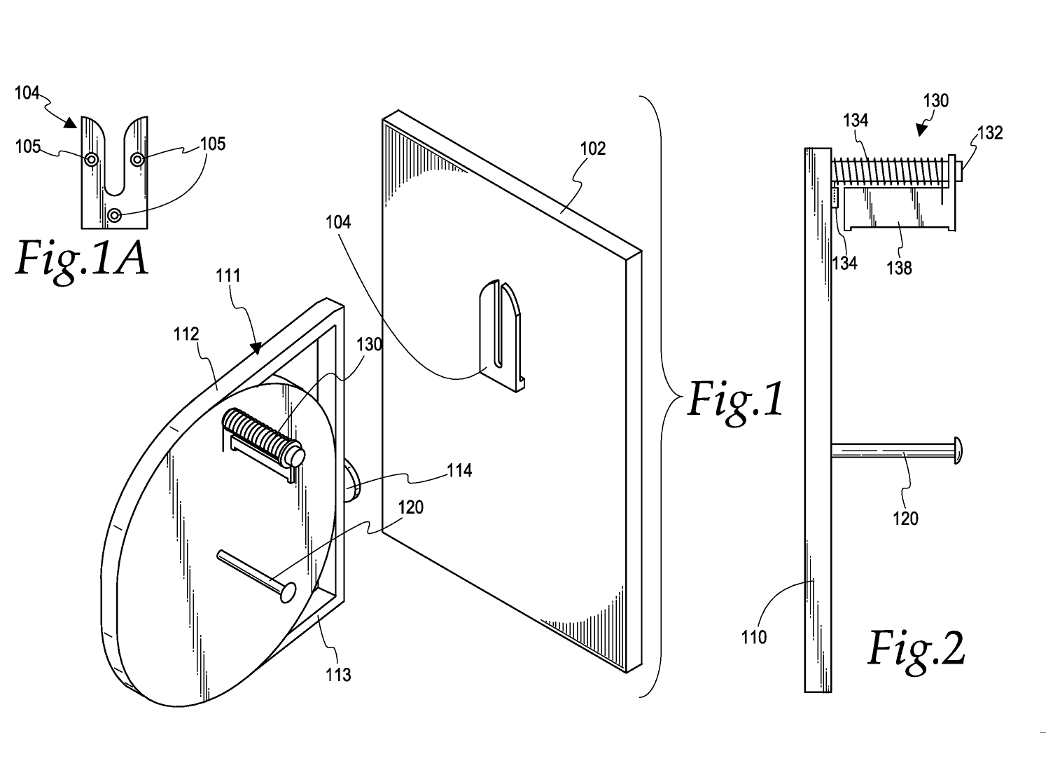

Turning to the figures, and to FIG. 1 in particular, a fishing line winding device constructed in accordance with this disclosure is depicted in exploded view, and generally designated as 100. The winding device comprises a mounting plate 102, which can be constructed of, for example, a plastic, such as polycarbonate, or of wood, or any other suitable material. In one embodiment of the disclosed winding device 100, the mounting plate has a hook and fastener backing that is adapted to couple with a hook and fastener sheet mounted on a wall. This allows the winding device to be used by an angler while in the field, such as, for example, when on a boat or when fishing from a pier. In one embodiment of the disclosed winding device 100, a mounting channel 104 can be formed on the surface of the mounting plate 102. Alternatively, the mounting channel 104 could be a separate formed piece, such as that depicted in FIG. 1a, that could, for example, include multiple screw holes 105, so that the mounting channel 104 could be screwed to the mounting plate 102. Finally, in certain embodiments, as discussed below, the operative portion of the winding device 100 can be formed directly with the mounting plate 102, and the mounting channel 104 would not be required.

As depicted, the winding machine 100 further comprises a circular backing plate 110 that is sized to be slightly larger than a typical spool of fishing line. The backing plate 110 is supported by a retainer 111 that comprises a top retaining beam 112 that couples to the top of the backing plate 110, and a bottom retaining beam 113 that couples to the bottom of the backing plate 110. The retainer 111 can, in certain embodiments, include a mounting protrusion 114 that is adapted to couple with the mounting channel 104. Alternatively, the rear beam 115 of the retainer 112 can be integrally formed to the mounting plate 102.

The backing plate 110 further comprises a center axle 120, on which a spool of fishing line can be mounted. It should be noted that a typical fishing line spool will comprise a center mounting aperture, and an angler will understand that the spool will be mounted onto the center axle 120 simply by situating the center hole of the spool onto the axle and pressing the side of the spool down until it is firmly held on the axle.

The winding machine 100 further comprises a spring-loaded tongue assembly 130 that is used to apply a small amount of pressure to the fishing line of the spool that is held by the center axle. The spring-loaded tongue assembly 130 is described in more detail with reference to FIG. 2.

FIG. 2 depicts a side view of the disclosed winding machine 100. In particular, the spring-loaded tongue assembly 130 is easily visible. The spring-loaded tongue assembly 130 comprises a post 132 that extends laterally outwards from the circular backing plate 110. The post 132 can be constructed of any suitable material, such as, for example, aluminum or a plastic, such as polycarbonate. A wire spring 134 is disposed around the post 132. One end of the wire spring 134 is disposed in a holder 136 that is disposed on or formed from the side of the backing plate 110. The other side of the spring 134 ends in a long hook (not shown) that is adapted to couple to a pressure tongue 138. The pressure tongue 138 can, for example, be formed of plastic and be approximately 9/16″ wide in one embodiment; i.e., a width suitable to apply pressure across the width of a typical spool of fishing line.

In operation a spool of fishing line is placed on the axle 120 and line is fed onto a fishing pole and tied to the fishing reel. The angler then turns the reel until the line is fed onto the reel. While the line is being fed onto the reel, the tongue 138 applies pressure onto the line, which prevents the formation of backlash.

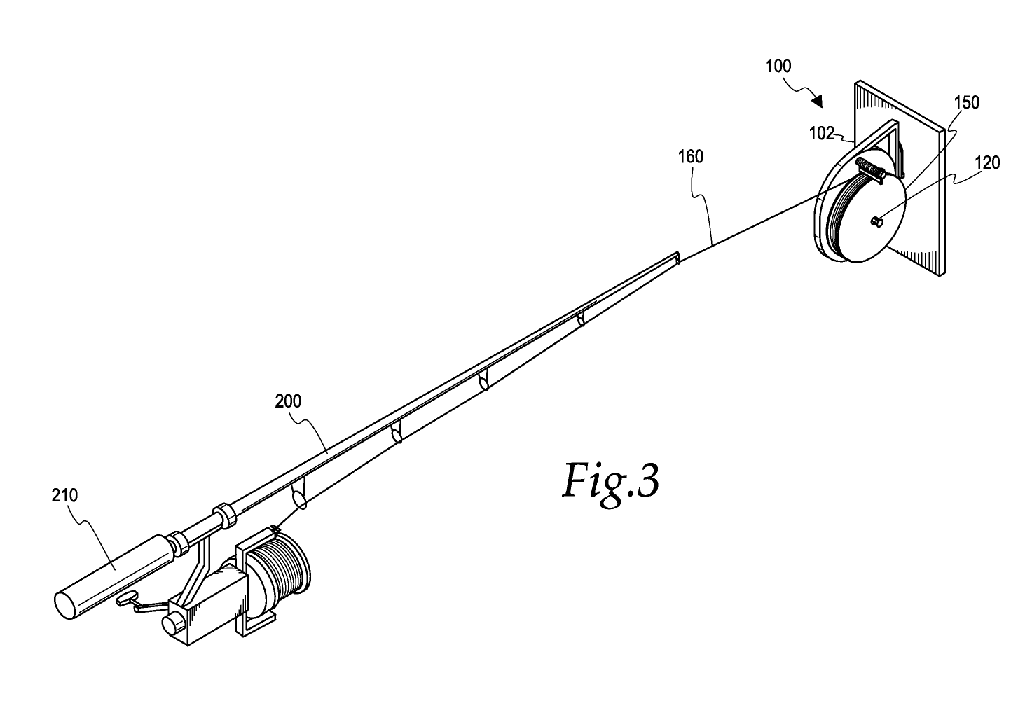

Turning to FIG. 3, a perspective view of the winding device 100 in operation while winding a reel 210 that is part of a fishing rod 200. In operation, the winding device 100 is coupled to a wall (not shown). The winding device 100 can be coupled to the wall by any prior art means, including screwing, nailing, gluing, or by coupling a hook and fastener back coupled to the back of the mounting plate 102 to a wall mounted hook and fastener sheet. A spool 150 of fishing line is coupled to the axis 120 of the winding machine 100 and the fishing line 160 is fed onto the reel 210 of the fishing rod 200. The angler then spins the reel 210 until the line is fully wound onto the reel 210.

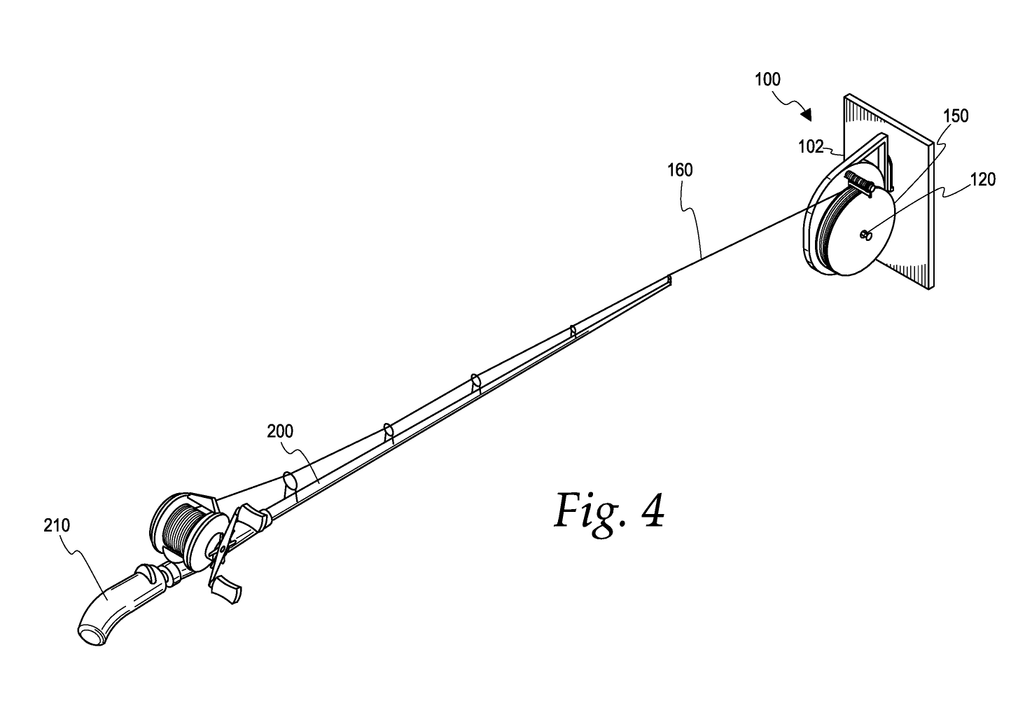

FIG. 4 is similar to FIG. 3, with the exception that FIG. 4 depicts the invention in use with a fishing rod that includes a baitcaster reel. It should be noted that the type of reel on the fishing rod is not a limitation of the disclosed winding machine, which can work with any type of fishing reel.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A winding machine for winding fishing line from a spool onto a reel comprising:
a substantially rectangular mounting plate;
a substantially circular backing plate coupled to the mounting plate;
a retainer comprising:
a first retaining beam coupled to the mounting plate and to a top of the circular backing plate;
a second retaining beam coupled to the mounting plate and to a bottom of the circular backing plate;
a center axle disposed at the center of the circular backing plate and extending laterally outwards from the circular backing plate;
a post disposed on the circular backing plate at a location radially outwards from the center axle and near the edge of the circular backing plate and wherein the post is also disposed near where the first retaining beam is coupled to the circular backing plate;
a spring disposed on said post, the spring having a first end; and
a tongue mounted on the first end of the spring.

2. The winding machine of claim 1 further comprising a mounting channel disposed on the substantially rectangular mounting plate, and wherein the retainer further comprises a rear beam with a protrusion disposed on the rear beam that is adapted to couple with the mounting channel.

3. The winding machine of claim 1 further comprising a holder coupled to backing plate on the same side as the post and wherein said spring further comprises a second end, and wherein said second end is disposed within said holder.

4. The winding machine of claim 1 wherein said mounting plate further comprises a hook and fastener backing.

5. The winding machine of claim 1 wherein said mounting plate is constructed of plastic.

6. The winding machine of claim 1 wherein said mounting plate is constructed of wood.
